(19) United States
(12) Patent Application Publication
(10) Pub. No.: US 2021/0089184 A1
(43) Pub. Date: Mar. 25, 2021

(54) PROXIMITY SENSORS ON TOUCHSCREEN

(71) Applicant: HEWLETT-PACKARD DEVELOPMENT COMPANY, L.P., Houston, TX (US)

(72) Inventors: Chen-Ta HUNG, Taipei, Taiwan (CN); Kai-Cheng CHI, Taipei, Taiwan (CN); Yung-Jui CHAO, Taipei City, Taiwan (CN)

(73) Assignee: HEWLETT-PACKARD DEVELOPMENT COMPANY, L.P., Houston, TX (US)

(21) Appl. No.: 16/084,985

(22) PCT Filed: Jun. 22, 2017
(86) PCT No.: PCT/US2017/038769

§ 371 Date: Sep. 14, 2018

(51) Int. Cl. G06F 3/041; G06F 3/044; H04B 1/3827

(52) U.S. Cl. CPC G06F 3/04164; G06F 3/0445; G06F 2203/04103; G06F 2203/04108; H04B 1/3838

(57) ABSTRACT

A touchscreen device includes a substrate and a proximity sensor. The proximity sensor includes a sensing area disposed on the substrate. The sensing area is separate from touch-sensing elements of the touchscreen device. The proximity sensor includes a conductive trace disposed on the substrate and connected to the sensing area. The conductive trace is to communicate a proximity signal from the sensing area to a proximity sensing circuit.

### BACKGROUND

Wireless communications devices, computer devices, and the like frequently include an antenna for transmitting signals to a network. Such an antenna uses electromagnetic radiation to transmit data or other signals.

Proximity sensors are often used in such devices to detect the body of a user and control antenna output to limit the user's exposure to electromagnetic radiation, as excessive exposure to electromagnetic radiation may affect the user's health.

### BRIEF DESCRIPTION OF THE DRAWINGS

FIG. 1 is a plan view of an example touchscreen device with an example proximity sensor.

FIG. 2 is a cross-sectional view of the example touchscreen device as part of an example computer device.

FIG. 3 is a plan view of an example computer device with an example proximity sensor.

FIG. 4 is a cross-sectional view of the example computer device.

FIG. 5 is a plan view of a portion of an example computer device with an example proximity sensor having separate sensing areas.

FIG. 6 is a plan view of a portion of an example computer device with an example proximity sensor having connected sensing areas.

FIG. 7 is a plan view of a portion of an example housing for a computer device showing an example proximity sensor.

FIG. 8 is a plan view of a portion of an example housing for a computer device showing another example proximity sensor.

FIG. 9 is a block diagram of an example computer device with an example proximity sensor.

FIG. 10 is a block diagram of an example touchscreen controller with an example proximity sensor.

FIG. 11 is a block diagram of example proximity sensing areas and supporting circuit.

FIG. 12 is a block diagram of example proximity sensing areas and supporting circuits.

FIG. 13 is a flowchart of an example method for making a touchscreen device including an integrated proximity sensor.

### DETAILED DESCRIPTION

Incorporating a proximity sensor into a computer device may make the design of other features of the device more difficult or complicated. Compactness of the device may suffer. Moreover, problems with the performance and manufacturability of the device may also result from poor proximity sensor design.

A proximity sensor may be disposed on a substrate of a touchscreen of a computer device, such as wireless communications device. The proximity sensor may be used to control an antenna to meet requirements for human exposure to electromagnetic radiation, such as Federal Communications Commission Office of Engineering & Technology (FCC OET) Bulletin 65 and similar. Locating the proximity sensor on the touchscreen substrate may allow the device to have an overall physical size that is thinner or smaller, or may make space for other components of the device. In addition, locating the proximity sensor on the substrate may readily allow for metal to be used for the housing of the device in the vicinity of the antenna and may offer compatibility with various antenna designs, such as slot antennas and windowless antennas.

An example touchscreen device 12 is shown in FIG. 1. The touchscreen device 12 includes a substrate 14 and may include touch-sensing elements 16 (partially shown) disposed on the substrate 14. The substrate 14 may include a layer or layers of glass, transparent dielectric material, polymer, adhesive, or similar. The touch-sensing elements 16 may include an array, grid, or other pattern of capacitive electrodes, such as indium tin oxide (ITO) electrodes, deposited on a layer of the substrate 14. The touch-sensing elements 16 may be used to detect a finger or other touch element, such as a stylus, by measuring a change in an electromagnetic field generated by the electrodes.

The touchscreen device 12 includes a proximity sensor 40. The proximity sensor 40 includes a sensing area 42 disposed on the substrate 14. The sensing area 42 is separate from the touch-sensing elements 16.

The proximity sensor 40 may further include a conductive trace 44 disposed on the substrate 14 and connected to the sensing area 42 to communicate a proximity signal from the sensing area 42. The conductive trace 44 may have an end 30 to connect the sensing area 42 to a proximity sensing circuit, which may be located on or off the touchscreen device 12.

The sensing area 42 and conductive trace 44 may be deposited on the substrate 14 using a similar or identical process as for depositing the touch-sensing elements 16. Depositing the sensing area 42 and conductive trace 44 on the substrate may be performed contemporaneously with depositing the touch-sensing elements 16 and any supporting conductive traces. Such process may include physical vapor deposition, electron beam evaporation, sputter deposition, or similar. The sensing area 42 and conductive trace 44 may be regions of deposited material that are separate and additional to the touch-sensing elements 16 and any supporting conductive traces.

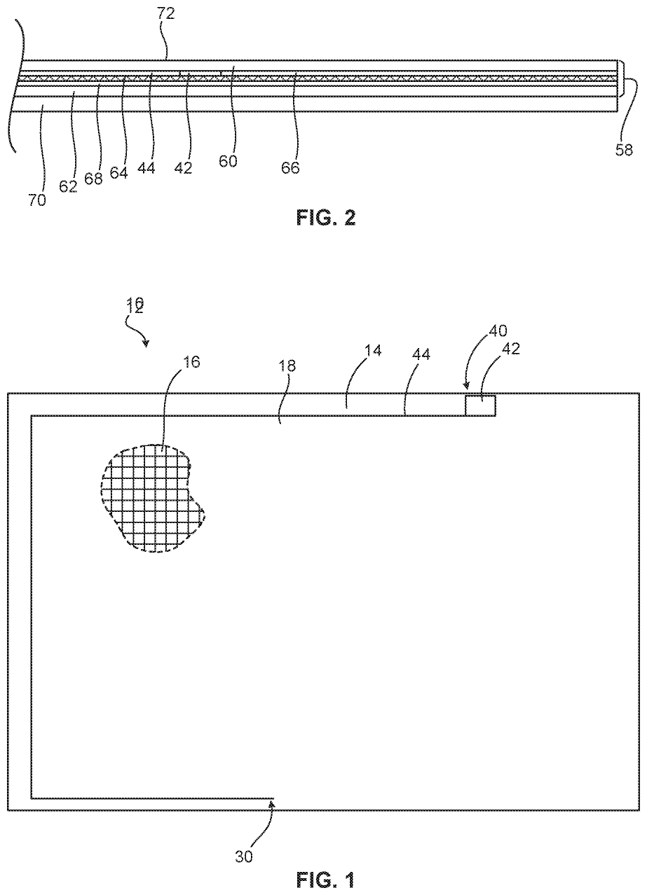

As shown in FIG. 2, the touchscreen device may include a layered substrate assembly 58 that includes an upper glass layer 60, a lower glass layer 62, and an adhesive layer 64 between the upper and lower glass layers 60, 62. A first array of electrodes 66, such as X-axis electrodes, may be deposited on the upper glass layer 60. A second array of electrodes 68, such as Y-axis electrodes, may be deposited on the lower glass layer 62. The adhesive layer 64 may be a transparent adhesive that bonds the upper and lower glass layers 60, 62 and electrically insulates the arrays of electrodes 66, 68 from each other. The touchscreen device may be disposed above a display device 70 to form a computer device or portion of a computer device. The display device may include a light-emitting diode (LED) display, liquid crystal display (LCD), or similar, such that light representing display information passes through the touchscreen device.

A top surface 72 of the upper glass layer 60 may be covered by a protective film, coating, cover glass, a lens, or similar to receive touches from the user.

The sensing area 42 and the conductive trace 44 of the proximity sensor 40 are integrated into the layered substrate assembly 58. The sensing area 42 and conductive trace 44 may be disposed on the upper glass layer 60, as shown. The sensing area 42 and conductive trace 44 may be disposed on the lower glass layer 62. The process of depositing the sensing area 42 and the conductive trace 44 on the substrate may be similar or identical to a process of depositing the electrodes 66, 68.

The layered structure shown in FIG. 2 is one illustrative example of locating a proximity sensor on a touchscreen substrate, and various other examples are contemplated. For example, the sensing area 42 may be disposed on the top surface 72 of the upper glass layer 60 or on a surface of the lower glass layer 62. The proximity sensor may be integrated with various touchscreen substrate assemblies.

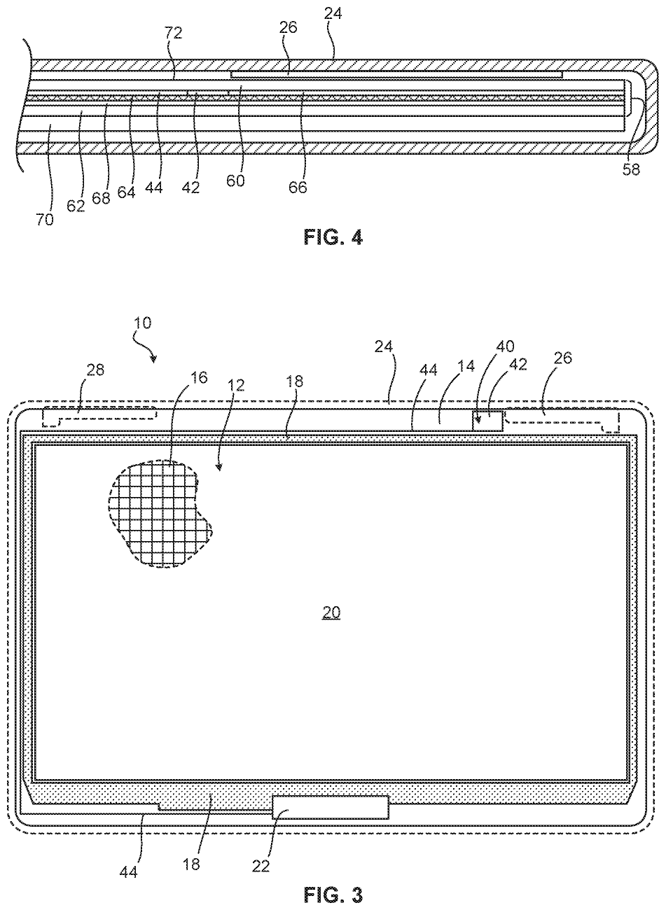

An example computer device 10 is shown in FIG. 3. The computer device 10 may be a device such as a notebook computer, a tablet computer, a netbook, a smartphone, a portion of such a device, or similar. For example, the computer device 10 may be an entire tablet computer. In another example, the computer device 10 may be the screen portion of a notebook computer, with the keyboard portion being omitted from view for clarity. The computer device 10 may be capable of wireless communications and may be referred to as a wireless communications device.

The computer device 10 may include a touchscreen device 12, such as that shown in FIG. 1.

The touch-sensing elements 16 of the touchscreen device 12 may be supported by an array of conductive traces 18, which may be disposed on the substrate 14 of the touchscreen device 12 at the periphery of the touch-sensing elements 16. The array of conductive traces 18 may border, partially surround, or fully surround a display area 20 of the touchscreen 12. The array of conductive traces 18 may be used to convey power and signal between the touch-sensing elements 16 and a component 22 of the device 10.

The conductive trace 44 may connect the sensing area 42 of the proximity sensor 40 to a component 22 to communicate a proximity signal from the sensing area 42 to a proximity sensing circuit, which may be included in the component 22 or may be connected to the component 22.

The component 22 may include a touchscreen controller that manages power and signal for the touch-sensing elements 16 to detect touches on the touchscreen 12. The component 22 may include a proximity sensing circuit to measure or detect a proximity signal from a proximity sensor, as discussed below. The component 22 may include a processor. The component 22 may include a bus or other array of conductors, such as a flexible printed circuit (FPC), that communicates signals and power with a circuit at another part of the device. In this latter example, the computer device 10 may be a notebook computer screen portion and the component 22 may be an FPC that connects to a circuit in the keyboard portion of the notebook computer.

The computer device 10 may include a housing 24 that contains and secures the touchscreen 12. The housing 24 may include several pieces, which may be made of plastic, metal, similar materials, or a combination of such.

An antenna 26 may be contained in the housing 24. The antenna 26 may be for transmission or for both transmission and reception of radio or other electromagnetic signals. The antenna 26 may be a wireless wide area network (WWAN) antenna, a wireless local area network (WLAN) antenna, or similar. The antenna 26 may be a slot antenna, a windowless antenna, or a combination of such. An auxiliary antenna 28 may be contained in the housing 24 at a location different from the location of the antenna 26. Any quantity of antennas may be provided for any types of wireless network. For example, multiple antennas may be used in a spatially multiplexed configuration, such as a 4×4 multiple-input and multiple-output (MIMO) system.

The proximity sensor 40 may be located adjacent the antenna 26. Adjacency may be taken to mean sufficiently close to detect the body of the user within range of the antenna 26 for the consideration of radiation exposure requirements. Adjacency may not necessarily mean touching or immediately adjacent.

The proximity sensor 40 includes a sensing area 42 disposed on the substrate 14 and separate from the touch-sensing elements 16. Hence, relying on the touch-sensing elements 16 to sense proximity of the user's body to control antenna transmission power may be avoided.

The sensing area 42 may be located outside the display area 20 of the touchscreen 12. The conductive trace 44 may be located outside the display area 20. The sensing area 42 and conductive trace 44 may be positioned such that the array of conductive traces 18 that supports the touch-sensing elements 16 of the touchscreen 12 is located between the display area 20 and the sensing area 42 and conductive trace 44. That is, the sensing area 42 and conductive trace 44 may be located at the outer periphery of the substrate 14.

The conductive trace 44 may be routed around the array of conductive traces 18 at the periphery of the substrate 14 for the entire length of the conductive trace 44. In other examples, the conductive trace 44 may be integrated into the array of conductive traces 18.

The sensing area 42 may be shaped and sized based on the properties of the materials used and any radiation exposure requirements being considered. An example shape is a rectangle. Shapes with curved edges may also be suitable. Example sizes include 15 mm by 10 mm, 10 mm by 10 mm, 5 mm by 5 mm, and similar. The conductive trace 44 may be made as narrow as possible to convey power and signal between the sensing area 42 and the component 22, while reducing or minimizing false triggering caused by the user's body in proximity to the trace 44. The sensing area 42 may have a smallest across dimension of at least five times a width of the conductive trace 44. The thickness of the sensing area 42 and its conductive trace 44, as deposited on the substrate 14, may be the same as that of the touch-sensing elements 16 and supporting conductive traces 18. The sizing and positioning of the sensing area 42 and conductive trace 44 may be selected to reduce or minimize negative effects on basic radiofrequency passive gain performance of the antenna 26.

The sensing area 42, conductive trace 44, touch-sensing elements 16, and array of conductive traces 18 may be deposited on the substrate 14 using a similar or identical process at the same time.

FIG. 4 shows an example of the region around the antenna 26 in cross section.

A layered substrate assembly 58 and display device 70 may be contained by the housing 24. The top surface 72 of the upper glass layer 60 of the layered substrate assembly 58 and any covering material may form part of the housing 24 or may be exposed to user touches via an opening in the housing 24.

The antenna 26 may be attached to or otherwise contained by an inside of the housing 24. The region of the housing 24 around the antenna 26 may be made of metal. For example, this region of the housing 24 may be a metal cover, which may be completely made of metal. The antenna 26 may be electrically insulated from the metal region.

The sensing area 42 may be adjacent the antenna 26, as depicted, in the sense that the sensing area 42 may be offset from the antenna 26 by at least the thickness of the upper glass layer 60, while being laterally positioned as close to the antenna 26 as practical to meet the radiation exposure safety requirements being implemented.

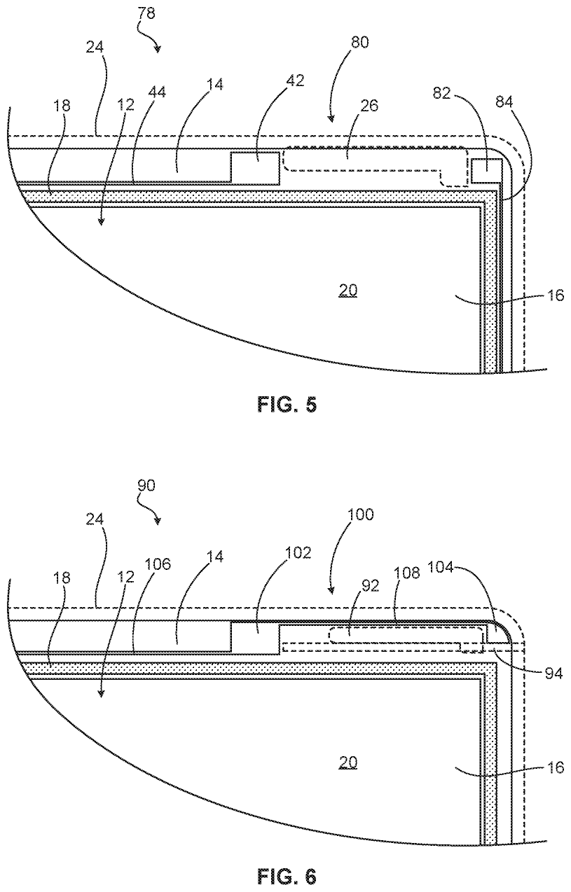

FIG. 5 shows another example computer device 78. The description for the other devices and circuits described herein may also be referenced, with like reference numerals indicating like components.

The computer device 78 includes a proximity sensor 80 that may include a first sensing area 42 and a second sensing area 82 that is separate from the first sensing area 42. The sensing areas 42, 82 may be disposed on a substrate 14 of a touchscreen device 12 as separate from the touch-sensing elements 16 of the touchscreen device 12.

The first sensing area 42 may be connected to a first conductive trace 44 and the second sensing area 82 may be connected to a second conductive trace 84. Each conductive trace 44, 84 may connect its respective sensing area 42, 82 to the component 22 (FIG. 3) to communicate a proximity signal from the respective sensing area 42, 82 to a proximity sensing circuit.

The sensing areas 42, 82 and conductive traces 44, 84 may be located outside the display area 20 of the touchscreen 12 at the outer periphery of the substrate 14.

The sensing areas 42, 82 may be disposed on the substrate at positions that surround the antenna 26. For example, the first sensing area 42 may be located adjacent one end of the antenna 26 and the second sensing area 82 may be located adjacent an opposite end of the antenna 26. The two sensing areas 42, 82 may be positioned to guard opposing ends of the antenna 26.

The conductive traces 44, 84 may be routed along different divergent paths, as depicted, around the array of conductive traces 18. In other examples, the conductive traces 44, 84 may be routed on parallel paths. In another example, each of the conductive traces 44, 84 may be integrated into the array of conductive traces 18 that supports the touch-sensing elements 16.

FIG. 6 shows another example computer device 90. The description for the other devices and circuits described herein may also be referenced, with like reference numerals indicating like components.

The computer device 90 may include an antenna 92 attached to the housing 24 and an antenna slot 94 in the housing 24 for receiving an insert.

The computer device 90 includes a proximity sensor 100 that may include a first sensing area 102 and a second sensing area 104 that is separate from the first sensing area 102. The sensing areas 102, 104 may be disposed on a substrate 14 of a touchscreen device 12 as separate from the touch-sensing elements 16 of the touchscreen device 12.

To communicate a proximity signal to a proximity sensing circuit, the first sensing area 102 may be connected to a first conductive trace 106 that connects to the component 22 (FIG. 3) and the second sensing area 104 may be connected to a second conductive trace 108 that connects to the first sensing area 102. The second conductive trace 108 may be routed around the antenna 92 and slot 94, so that the sensing areas 102, 104 may be located on opposite sides of the antenna 92 and slot 94.

The sensing areas 102, 104 may be disposed on the substrate at positions that surround the antenna 92 and slot 94. For example, the first sensing area 102 may be located adjacent one end of the slot 94 and the second sensing area 104 may be located adjacent an opposite end of the slot 94 near the outside end of the antenna 92.

The first sensing area 102 may be rectangular in shape and the second sensing area 104 may have a curved edge to accommodate the curved shape of the housing 24. The second sensing area 104 may be sized to avoid overlapping the slot 94.

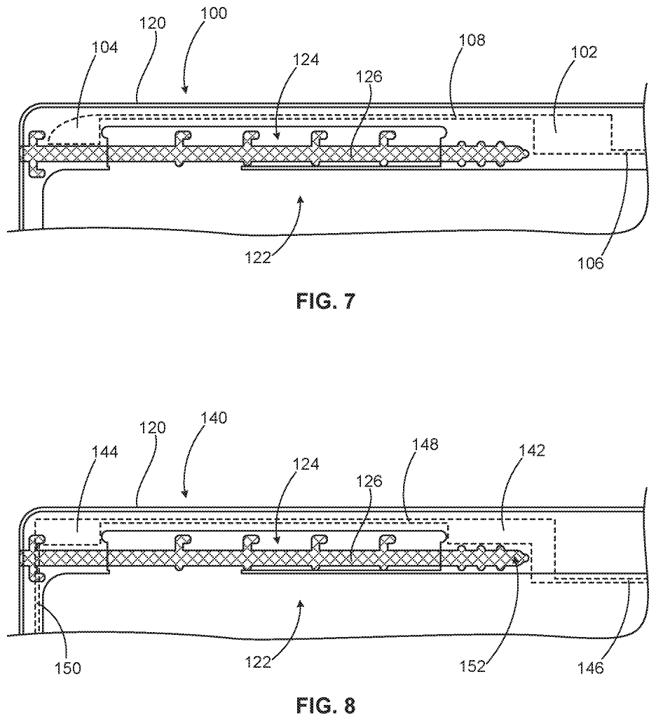

FIG. 7 shows a portion of an example housing for a computer device, such as a portion of a back cover 120 of a notebook or tablet computer, as viewed from the inside or from the opposite direction as FIG. 6. The description for the other devices and circuits described herein may also be referenced, with like reference numerals indicating like components.

The cover 120 may include a main cavity 122 for containing components of the computer device, such as a touchscreen, camera, integrated circuits, and similar. The cover 120 may include an antenna cavity 124 for containing a printed circuit board (PCB) of an antenna, such as a slot antenna. Further, the cover 120 may contain a slot insert 126 for the slot antenna.

The cover 120 may include metal, such as aluminum, magnesium, steel, alloys of such, or similar, in the region around the antenna cavity 124 and slot insert 126. The cover 120 may be entirely made of metal.

A proximity sensor 100 is integrated into a touchscreen substrate assembly of the computer device, as discussed elsewhere herein, that may be used with the cover 120. The proximity sensor 100 may include a first sensing area 102 and a second sensing area 104 mutually connected by a conductive trace 108, as well as another conductive trace 106 that connects the first sensing area 102 to a proximity sensing circuit, such as the component 22 (FIG. 3). The sensing areas 102, 104 may be positioned to surround the antenna cavity 124 and slot insert 126. For clarity, the proximity sensor 100 is shown in hidden line in the figure, due to the touchscreen being omitted from view.

FIG. 8 shows a portion of an example housing for a computer device, such as a portion of a back cover 120 of a notebook or tablet computer, as viewed from the inside. The description for the other devices and circuits described herein may also be referenced, with like reference numerals indicating like components.

A proximity sensor 140 is integrated into a touchscreen substrate assembly of the computer device, as discussed elsewhere herein, that may be used with the cover 120. The proximity sensor 140 may include a first sensing area 142 and a second sensing area 144. The proximity sensor 140 may further include first conductive trace 146 that connects the first sensing area 142 to a proximity sensing circuit, such as the component 22 (FIG. 3). The proximity sensor 140 may include a second conductive trace 150 that connects the second sensing area 144 to the proximity sensing circuit. An additional conductive trace 148 may be provided to mutually connect the first sensing area 142 and the second sensing area 144. The sensing areas 142, 144 may be positioned to surround the antenna cavity 124 and slot insert 126.

The first sensing area 142 may be L-shaped to fit around the end 152 of the slot insert 126 and still provide sufficient area for proximity detection. The second sensing area 144 may be rectangular. Other shapes for the sensing areas 142, 144 may also be used. The sensing areas 142, 144 may each be shaped to avoid overlapping the slot insert 126. Total avoidance of overlap may not be necessary.

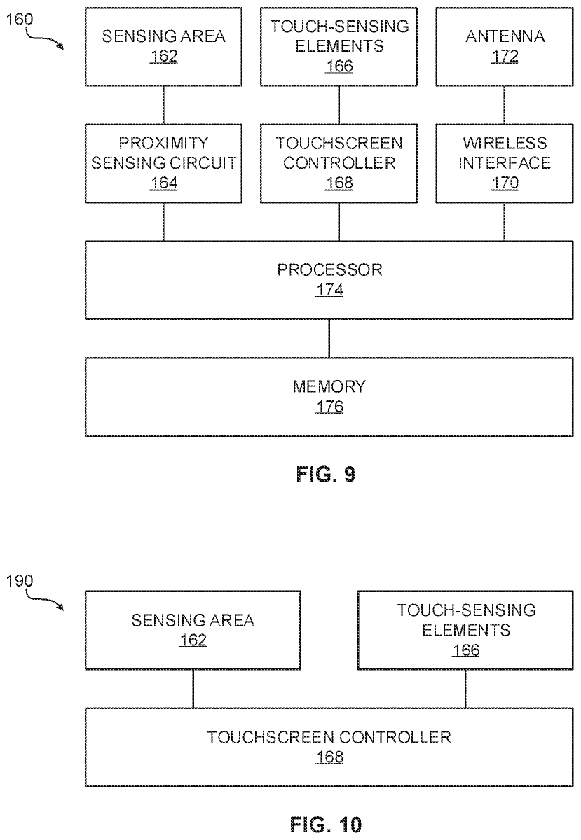

FIG. 9 shows a block diagram of an example computer device 160. The description for the other devices and circuits described herein may also be referenced, with like reference numerals indicating like components.

The computer device 160 includes a sensing area 162 connected to a proximity sensing circuit 164 by a conductive trace. The sensing area 162 and conductive trace may be integrated with a touchscreen substrate assembly, as discussed elsewhere herein.

The computer device 160 may further include a touchscreen device that includes touch-sensing elements 166 connected to a touchscreen controller 168 to implement a touchscreen. The touch-sensing elements 166, touchscreen controller 168, and related conductors may form a channel for touch-sensing data.

The computer device 160 may further include a wireless communications interface 170 and an antenna 172, such as a WWAN or WLAN chipset and antenna.

The computer device 160 may further include a processor 174 and memory 176. The processor may include a CPU, a microcontroller, a microprocessor, a processing core, a field-programmable gate array (FPGA), or similar. The processor 174 may execute instructions stored in memory 176. The memory may include any electronic, magnetic, optical, or other non-transitory machine-readable storage medium that stores executable instructions. The memory 176 may include, for example, static random access memory (RAM), dynamic RAM, flash memory, or similar.

The proximity sensing circuit 164 may provide a capacitive charge to the sensing area 162. The presence of a user's body near the sensing area 162 may disturb the electromagnetic field established by the capacitive charge, and such disturbance may be detected by the proximity sensing circuit 164 as a proximity signal. The path of the proximity signal may be considered a proximity-sensing channel that is separate from the touch-sensing channel. The proximity sensing circuit 164 may be to compare the proximity signal to a threshold and provide such determination to the processor 174 to control transmission power of the antenna 172. In other examples, the comparison of the proximity signal to a threshold may be performed by instructions at the processor 174. Multiple thresholds may be used for respective multiple antenna power output levels. The threshold may be set by instructions at the processor 174.

FIG. 10 shows a block diagram of an example touchscreen device 190. The description for the other devices and circuits described herein may also be referenced, with like reference numerals indicating like components. For example, the touchscreen device 190 may be used with the computer device 160 or with any of the other computer devices discussed herein.

The touchscreen device 190 includes a sensing area 162 connected to a touchscreen controller 168 by a conductive trace. The sensing area 162 and conductive trace may be integrated with a touchscreen substrate assembly, as discussed elsewhere herein.

The touchscreen device 190 may further include touch-sensing elements 166 connected to the touchscreen controller 168 through a touch-sensing channel. The touchscreen controller 168 may be connected to a processor.

The touchscreen controller 168 may be to control a touchscreen implemented by the touch-sensing elements 166. Further, the touchscreen controller 168 may be to provide a capacitive charge to the sensing area 162 to detect a proximity signal from the sensing area 162. Hence, the touchscreen controller 168 may support both touch sensing and proximity detection, with proximity detection on a channel separate from the touch-sensing channel.

FIG. 11 shows example proximity sensing areas connected to an example proximity sensing circuit. The description for the other devices and circuits described herein may also be referenced, with like reference numerals indicating like components.

Multiple sensing areas 162 may be connected to a proximity sensing circuit 164 to establish multiple proximity-sensing channels. The proximity-sensing channels may be separate from a touch-sensing channel. The proximity sensing circuit 164 may control and detect proximity sensing signals on each channel independently.

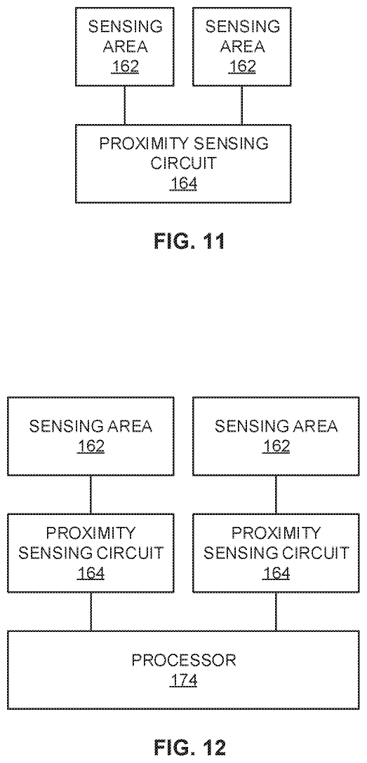

FIG. 12 shows example proximity sensing areas connected to example proximity sensing circuits. The description for the other devices and circuits described herein may also be referenced, with like reference numerals indicating like components.

Multiple sensing areas 162 and multiple proximity sensing circuits 164 are provided. Each sensing area 162 may be connected to a respective proximity sensing circuit 164. All of the proximity sensing circuits 164 may be connected to the same processor 174. Each proximity sensing circuit 164 may independently control and detect proximity sensing signals from the connected sensing area 162.

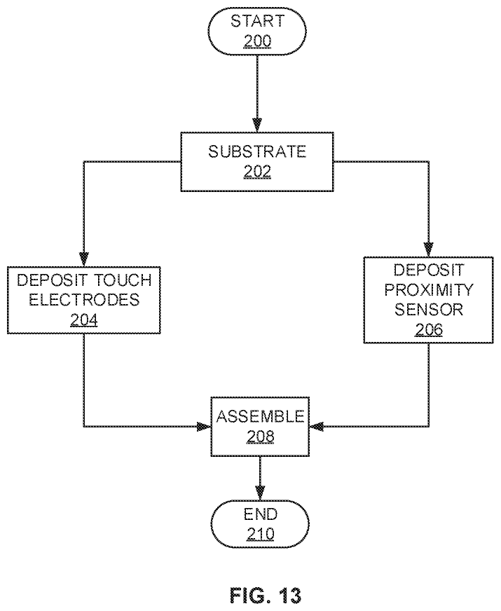

FIG. 13 shows an example method of making a touchscreen device with an integrated proximity sensor. The method may be used to manufacture any of the devices discussed herein. The method starts at block 200. At block 202, a substrate is provided and prepared to carry touch-sensing electrodes and a separate proximity sensor. At block 204, the touch-sensing electrodes are deposited on the substrate using a process such as physical vapor deposition or similar, as described elsewhere herein. At block 206, a sensing area and a conductive trace of the proximity sensor are deposited on the substrate, with the sensing area and conductive trace being connected. Blocks 204 and 206 may be performed at the same time and may be performed using the same depositing process. The sensing area is deposited at a separate location from the touch-sensing electrodes, such as a location that is to be adjacent an antenna when the touchscreen device is installed in a computer device. The deposited conductive trace is to communicate a proximity signal from the sensing area to a proximity sensing circuit. Hence, the end of the conductive trace not connected to the sensing area may be positioned at a location that may be readily connected to a component that includes the proximity sensing circuit or that is to be connected to the proximity sensing circuit. At block 208, the substrate is assembled with another substrate into a substrate assembly. This may include adhering or bonding the substrates together, adhering or bonding additional substrates, applying a coating, and similar. The method ends at block 210 and the touchscreen device may then be assembled into a computer device.

As discussed above, a proximity sensor, including a sensing area and conductive trace, may be integrated into a touchscreen substrate assembly while remaining separate from the touch-sensing functionality of the touchscreen device. Multiple of such sensing regions may surround a wireless transmission antenna at positions that have reduced or minimal effect on basic passive gain performance of the antenna. The proximity sensor may allow the device to meet electromagnetic field safety requirements defined, for example, in FCC Knowledge Database (KBD) publication numbers 616217 and 447498. Metal may be used in the housing or cover in the region of the antenna and proximity sensor, and the need for a metal foil proximity sensor adhered to a plastic housing or cover may be reduced or eliminated. The same or similar process of depositing touch-sensing electrodes may be used to deposit the proximity sensor on the glass or other substrate, which may reduce or eliminate manufacturing inconsistencies that may lead to devices being rejected at inspection or returned by the user. Proximity and touch sensing signals may be kept on separate channels, which may be served by the same circuit, to reduce complexity in integrating a proximity sensor into a touchscreen substrate assembly.

It should be recognized that features and aspects of the various examples provided above can be combined into further examples that also fall within the scope of the present disclosure.

1. A touchscreen device comprising:
a substrate; and
a proximity sensor including a sensing area disposed on the substrate, the sensing area separate from touch-sensing elements of the touchscreen device;
the proximity sensor including a conductive trace disposed on the substrate and connected to the sensing area, the conductive trace to communicate a proximity signal from the sensing area to a proximity sensing circuit.

2. The device of claim 1, wherein the substrate comprises a glass layer.

3. The device of claim 1, further comprising an array of conductive traces of the touch-sensing elements, the array of conductive traces disposed on the substrate, the array of conductive traces located between a display area of the touchscreen device and the conductive trace of the proximity sensor.

4. The device of claim 1, wherein the conductive trace is located outside a display area of the touchscreen device.

5. The device of claim 1, wherein the sensing area has a smallest across dimension of at least five times a width of the conductive trace.

6. The device of claim 1, wherein the sensing area is a first sensing area and the proximity sensor further includes a second sensing area disposed on the substrate, the second sensing area separate from the first sensing area and the touch-sensing elements.

7. The device of claim 6, wherein the conductive trace is a first conductive trace and the proximity sensor further includes a second conductive trace disposed on the substrate and connected to the second sensing area.

8. The device of claim 7, wherein the second conductive trace is connected to the first sensing area.

9. The device of claim 7, wherein the second conductive trace is to communicate a proximity signal from the sensing area to a proximity sensing circuit.

10. A computer device comprising:
a touchscreen including a layered substrate assembly including touch-sensing elements; and
a proximity sensor including a sensing area and a conductive trace to communicate a proximity signal from the sensing area to a proximity sensing circuit, the sensing area separate from the touch-sensing elements, the sensing area and the conductive trace integrated into the layered substrate assembly of the touchscreen.

11. The device of claim 10, further comprising:
an antenna, the proximity sensor located adjacent the antenna; and
a circuit to control transmission power of the antenna based on the proximity signal.

12. The device of claim 11, wherein the proximity signal is communicated to the circuit via a channel separate from a touch-sensing channel of the touchscreen.

13. The device of claim 12, wherein the proximity signal is communicated to the circuit via multiple channels including the channel.

14. The device of claim 11, further comprising a housing, the housing including a metal region at the antenna.

15. A method of making a touchscreen, the method comprising:
depositing touch-sensing electrodes onto a substrate;
depositing onto the substrate a proximity sensor including a sensing area and a conductive trace connected to the sensing area, the sensing area being separate from the touch-sensing electrodes, the conductive trace to communicate a proximity signal from the sensing area to a proximity sensing circuit; and
assembling the substrate into a substrate assembly.
